(19) United States
(12) Patent Application Publication
(10) Pub. No.: US 2025/0278294 A1
(43) Pub. Date: Sep. 4, 2025

(54) LOW OVERHEAD PROCESSOR SWITCHING

(71) Applicant: BMC Software, Inc., Houston, TX (US)

(72) Inventors: Jason Ronald Torola, Katy, TX (US); Pradnya Prakash Shah, Pune (IN)

(21) Appl. No.: 18/592,367

(22) Filed: Feb. 29, 2024

(51) Int. Cl. G06F 9/48; G06F 9/30

(52) U.S. Cl. CPC G06F 9/4856; G06F 9/30189

(57) ABSTRACT

Described techniques provide in-line, low overhead processor switching. Using a first control block of a first processor, a second control block of a second processor may be initialized. A switching state may be provided that enables switching code execution control between the first control block and the second control block, the switching state including at least one switching routine address for at least one switching routine. First code may be executed at the first control block. Then, processor control may be switched from the first processor to the second processor, using the at least one switching routine obtained using the at least one switching routine address of the switching state. Second code may then be executed at the second control block on the second processor.

### TECHNICAL FIELD

This description relates to processor management.

### BACKGROUND

Many computer systems are capable of utilizing multiple processors, and multiple types of processors, to execute applications, perform tasks, or do other types of work. For example, some processors are designed to perform certain types of tasks better than other types of tasks. In other examples, some processors may be more efficient and/or less costly to use in some contexts than in others.

In many cases, however, it may be problematic to determine whether, when, or to what extent such processor switching should occur. For example, switching between processors may incur a corresponding overhead with respect to scheduling resources needed to execute the switch, and such overhead may partially or completely negate a desired benefit of a switching between processors. In other examples, a task being switched to an alternate processor may include operations that cannot, or should not, be performed on the alternate processor.

### SUMMARY

According some general aspects, a computer program product may be tangibly embodied on a non-transitory computer-readable storage medium and may include instructions. When executed by at least one computing device, the instructions may be configured to cause the at least one computing device to initialize, using a first control block of a first processor, a second control block of a second processor. When executed, the instructions may be further configured to cause the at least one computing device to provide a switching state that enables switching code execution control between the first control block and the second control block, the switching state including at least one switching routine address for at least one switching routine. When executed, the instructions may be further configured to cause the at least one computing device to execute a first code at the first control block. When executed, the instructions may be further configured to cause the at least one computing device to switch processor control from the first processor to the second processor, using the at least one switching routine obtained using the at least one switching routine address of the switching state. When executed, the instructions may be further configured to cause the at least one computing device to execute a second code at the second control block on the second processor.

According to other general aspects, a computer-implemented method may perform the instructions of the computer program product. According to other general aspects, a system, such as a mainframe system or a distributed server system, may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for low overhead processor switching.

FIG. 2 is a flowchart illustrating example operations of the system of FIG. 1.

FIG. 3 is a block diagram of an example implementation for processor switching.

FIG. 4 is a block diagram illustrating more detailed example operations of the example of FIG. 3.

FIG. 5 is a block diagram illustrating additional example operations of the example of FIG. 4.

FIG. 6 is a flowchart illustrating an example dynamic recovery operation for use in the examples of FIGS. 3-5.

FIG. 7 is an example of program code that may be used in the examples of FIGS. 3-6.

### DETAILED DESCRIPTION

Described systems and techniques enable, for example, seamless, in-line switching between available processors when executing code. By using different processors based on a type or nature of code to be executed, the described techniques are able to improve system performance, increase system efficiency, and reduce system costs.

Multi-processor systems may impose or exhibit limitations with respect to which type(s) of workloads, tasks, processes, routines, or other types of work may be performed on each processor. Therefore, attempting to run code on a processor that is not suitable for that processor may result in an error or system failure.

Moreover, the same code may execute more quickly or more efficiently on one type of processor than another. Consequently, poor selection of a processor for corresponding code execution may result in longer and/or higher system usage.

Further, even if code is correctly identified and assigned for execution using a given set of processors, switching between the processors to execute different code portions may result in undesirable levels of overhead. For example, scheduling and related activities may consume more time and/or other resources than are saved through switching among different processors.

Described techniques enable in-line switching between processors by saving an environment or switching state that is available to, and accessible by, two or more processors. For example, the switching state may include, or specify, the data and instructions needed for a second processor to begin immediate execution of transferred code from a first processor.

The switching state may be updated during operations of the second processor. Therefore, the updated switching state may include or specify data and instructions needed for the first processor to resume execution of transferred code from the second processor once the second processor has completed an assigned code execution.

For example, resumption of execution of relevant code by the first processor may occur at an end of execution of code assigned to the second processor (e.g., at the end of an executed routine). In other examples, resumption of execution of transferred code by the first processor may occur during execution of code assigned to the second processor (e.g., during execution of a routine). For example, responsibility for code execution may be dynamically transferred from the second processor to the first processor in response to an error that occurs during execution at the second processor, or in response to ineligible code that is not allowed to be run using the second processor. Then, in some examples, error resolution and/or execution of the ineligible code at the first processor may enable a re-transfer of the code (e.g., routine) back to the second processor for further execution or completion.

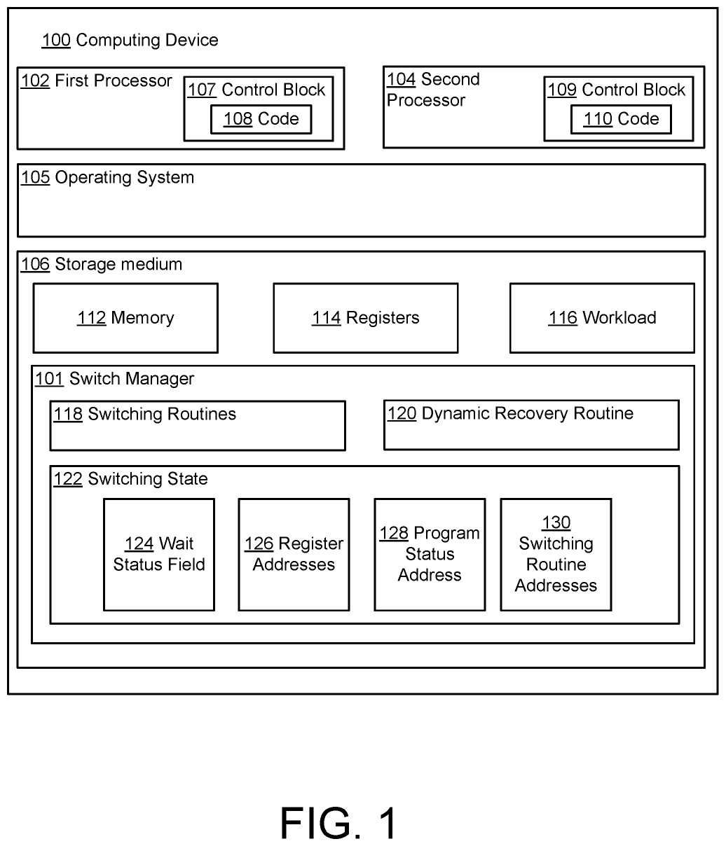

FIG. 1 is a block diagram of a system for low overhead processor switching. In the example of FIG. 1, a computing device 100 includes a switch manager 101 that is configured to implement processor switching between multiple processors, represented in FIG. 1 by a first processor 102 and a second processor 104. The switch manager 101 may be stored using at least one non-transitory, computer-readable storage medium 106.

The first processor 102 and the second processor 104 may represent any two (or more) processors that may be included in, or accessible by, the computing device 100, and that are compatible with respect to executing at least one set of instructions stored using the storage medium 106. That is, a user of the computing device 100 should be understood to have some ability to determine whether to execute at least one set of instructions using either or both of the first processor 102 and the second processor 104.

In the example of FIG. 1, and in subsequent examples, the computing device 100 may represent a mainframe computing device, which may also be referred to herein as a mainframe computer or a mainframe. A mainframe computing device refers to any computer, or combination of computers in communication with one another, used to implement mainframe applications and otherwise provide centralized processing for many different workstations or terminals, e.g., in a corporate environment.

For example, a mainframe computing device may be deployed by a business owner or organization, e.g., to support business functions. A mainframe may support, include, or be connected to, many different workstations or peripheral devices, or otherwise provide access and business functions to employees, administrators, customers, or other users. For example, such mainframe systems may provide core functionalities in healthcare, insurance, banking and finance, energy and oil and gas, manufacturing, or industrial settings, and may store and process vast amounts of data for millions of customers or other users.

The computing device 100 may utilize an operating system 105 to perform various tasks, jobs, or other processes. For example, multiple applications may continuously require jobs to be performed by the operating system 105. The operating system 105 may, for example, provide task scheduling, application execution, and peripheral control. For example, in a mainframe environment, the operating system 105 may represent the z/OS® operating system. In other examples, such an operating system may use a z/OS Unix® system, or a Linux system. Portions or code of such an operating system may also be stored using suitable memory of the at least one storage medium 106 and executed by a suitable processor(s).

In FIG. 1, the first processor 102 and the second processor 104 may represent two types of processors usable by the computing device 100, which, as described herein, have overlapping capabilities with respect to code execution. In the example of FIG. 1, the first processor 102 is illustrated as using a control block 107 to execute code 108, while the second processor 104 is illustrated as using a control block 109 to execute code 110.

In the present description, control blocks, such as the control blocks 107, 109, refer to memory areas and included data related to event and state information for corresponding code. Thus, control blocks 107, 109 may also be referenced with respect to the storage medium 106, but are illustrated exclusively in FIG. 1 in the context of the first processor 102 and the second processor 104, respectively, in order to illustrate associations therebetween, as well as to illustrate corresponding associations with the code 108 and the code 110, also respectively.

Control blocks, such as the control blocks 107, 109, enable tracking and control of processor operations, including code execution, by the operating system 105. A control block may also be used to control or interact with another control block. For example, the control block 107 may represent a parental control block that schedules the control block 109 to operate as a child control block.

For example, the code 108 may be limited to execution using the first processor 102 (e.g., may not be executed by the second processor 104), while the code 110 may be executable by either the first processor 102 or the second processor 104. As noted above, the second processor 104 may be faster, more efficient, or less expensive to operate than the first processor 102, so that it is preferable to execute the code 110 using the second processor 104 when feasible.

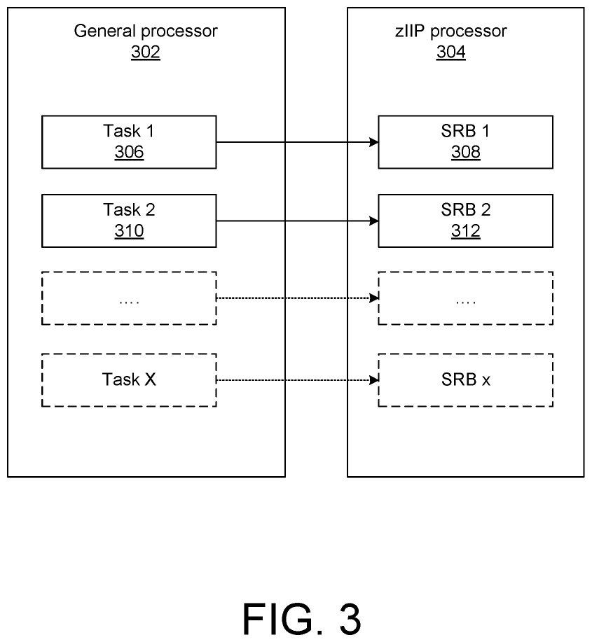

In the following examples, as referenced above and described in more detail, below, with respect to FIGS. 3-7, the operating system 105 may represent a type of z/OS or similar operating system in a mainframe environment. The first processor 102 may represent a general purpose processor, and the second processor 104 may represent a specialized processor, such as a z Integrated Information Processor (zIIP). In these examples, the control block 107 may represent a task control block (TCB), while the control block 109 may represent a service request block (SRB). Such scenarios provide examples of the types of situations referenced above, in which the second processor 104 (e.g., a zIIP processor) provides execution advantages with respect to execution of the code 110, as compared to executing the code 110 using the first processor 102.

In other examples, techniques may be implemented to execute the SRB without utilizing a zIIP. For example, the SRB may be scheduled to execute in a different address space than an address space of a scheduling TCB, so that each time a switch occurs between the TCB and the SRB, cross-memory code execution may occur.

The storage medium 106 may include various types of storage media, e.g., may represent quantities of various types of memory that may be used to store such code, as well as to store data that may be used by, or output by, such executed code. In the simplified example of FIG. 1, the storage medium 106 is illustrated as including memory 112, which may generally represent main memory or bulk memory of, or accessible by, the computing device 100, as well as registers 114. For example, the registers 114 may be used to buffer or temporarily store instructions or other data read from the memory 112 for loading to, and execution by, either of the first processor 102 and the second processor 104.

For example, in FIG. 1, a workload 116 represents any set of instructions that may be stored using the memory 112, or other suitable memory of the storage medium 106. The workload 116 should be understood to include the code 108 and the code 110, which, in FIG. 1, may be loaded into the registers 114 and from there to the appropriate one of the processors 102, 104 for execution, as illustrated.

For example, the workload 116 may represent an application or a part of an application being executed by the computing device 100 for one of the various purposes described above. In a mainframe environment, many such different applications may leverage the operating system 105, which may be responsible for scheduling, assigning, and dispatching units of work of the workload 116 to an appropriate one of the processors 102, 104 for execution.

For example, such an application may be configured to provide virtually any service or function that may be usable in the many contexts in which the computing device 100 may be deployed, such as in the healthcare, insurance, banking and finance, energy and oil and gas, manufacturing, or industrial settings referenced above. Applications may be written using any known mainframe-compatible programming languages, such as, e.g., COBOL, PL/1, or Assembler.

The switch manager 101 may include multiple routines used to execute processor switches between the first processor 102 and the second processor 104. The switch manager 101 may further include or identify various addresses, fields, or other locations within the memory 112 or the registers 114 from which information needed to execute processor switching may be obtained. Although illustrated in FIG. 1 as being stored using the storage medium 106, it will be appreciated that portions of (e.g., information from) the switch manager 101 may be loaded to, or accessed by, an appropriate one of the processors 102, 104 when needed for execution of switch-related operations.

In FIG. 1, the switch manager 101 may include switching routines 118, which refer to pre-defined routines designed to switch a processing context between the first processor 102 and the second processor 104. For example, the switching routines 118 may include a first routine for switching from the first processor 102 to the second processor 104, and a second routine for switching from the second processor 104 to the first processor 102.

The switch manager 101 may further include a dynamic recovery routine 120. As noted above, some code may be incompatible with operation using the second processor 104. For example, an entirety of the code 108 or a portion of the code 110 may be incompatible with executing on the second processor 104. Therefore, executing such incompatible code may result in an execution error.

The dynamic recovery routine 120 may be configured to recover from such errors or incompatibilities in the event that they occur. For example, the dynamic recovery routine 120 may be configured to utilize the switching routines 118 to enable execution of error-containing code (or code portion) in the second processor 104, using the first processor 102.

For example, the code 108 and the code 110 may be consecutive code portions of an application or other workload, or the code 110 may include one or more routines included within the code 108. The code 110 may include a code portion that is not executable using (e.g., is incompatible with) the second processor 104.

During or following execution of the code 108 using the first processor 102, an appropriate one of the switching routines 118 may be used to switch to the second processor 104 for execution of the code 110. Upon encountering the above-referenced error caused by inclusion of the incompatible code portion of the code 110, the dynamic recovery routine 120 may cause the incompatible code portion of the code 110 to be executed by the first processor 102.

Subsequently, in some examples, a remaining portion of the code 110 and of the code 108, if any, may be executed by the first processor 102. In other examples, following execution at the first processor 102 of the code portion of the code 110 that was incompatible with execution using the second processor 104, the dynamic recovery routine 120 and/or the switching routines 118 may be used to switch execution context back to the second processor 104 to execute remaining portions of the code 110 there.

In order to enable operations of the switching routines 118 and the dynamic recovery routine 120, a switching state 122 may be defined that stores a context, environment, or other state information that may be useful in facilitating switching between the first processor 102 and the second processor 104. The switching state 122 may include various types of information, which may be stored using the storage medium 106. In some examples, the switching state 122, or a memory portion in which the switching state 122 is stored, may be referred to as a token, or token area.

For example, the switching state 122 may include one or more wait status field(s) 124. The wait status field 124 may be used to indicate a current waiting or pause status of the second processor 104 (e.g., of the control block 109) while waiting for work to be assigned, and/or a current waiting/paused status of the first processor 102 (e.g., of the control block 107) while waiting for the second processor 104 to complete execution of assigned code (e.g., the code 110).

Register addresses 126 refer to specific register fields of the registers 114 used to store information that will be used by a waiting processor/control block to commence or recommence workload execution. For example, the first processor 102 may complete execution of the code 108 while the second processor 104 is waiting. The first processor 102 (e.g., the control block 107) may use the register addresses 126 to designate information (e.g., code instructions and/or data) needed by the second processor 104 and stored using the registers 114 to commence execution of the code 110.

Such execution of the code 110 will typically include corresponding further updates to the contents of the registers 114. Therefore, upon completion of execution of the code 110, the second processor 104 through use of e.g., the control block 109, may use the register addresses 126 to designate or identify the updated information within the registers 114 needed by the first processor 102 to continue operations of some portion of code (not shown in FIG. 1).

A program status address 128, which may also be referred to as a program status word (PSW) refers to a memory location or area, e.g., within the memory 112 or the registers 114, at which a waiting processor should begin execution. For example, upon completion of the code 108 by the first processor 102, the program status address 128 may be updated with an address of a current and the next instruction to be executed to commence execution of the code 110.

The switching state 122 may further include switching routine addresses 130. That is, the switching routine addresses 130 may specify a memory location or address, e.g., within the memory 112, at which each of the switching routines 118 may be accessed.

Thus, FIG. 1 illustrates an example implementation in which workload 116, including the code 108 and the code 110, may be executed using the first processor 102 and the second processor 104. Through the use of the switch manager 101, in conjunction with the control blocks 107, 109, processor switches may be executed using inline code within the workload 116, and without a need to schedule a new control block for each switching instance.

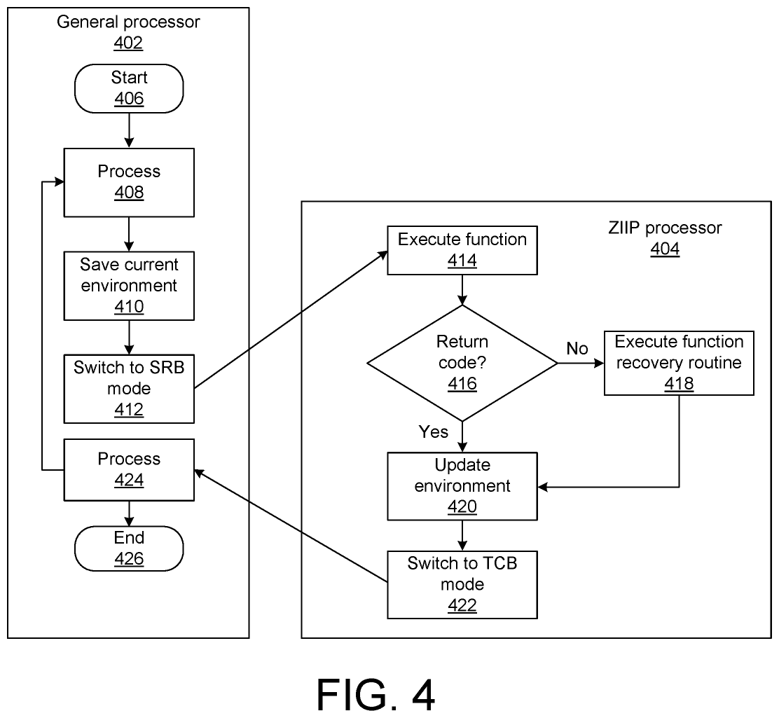

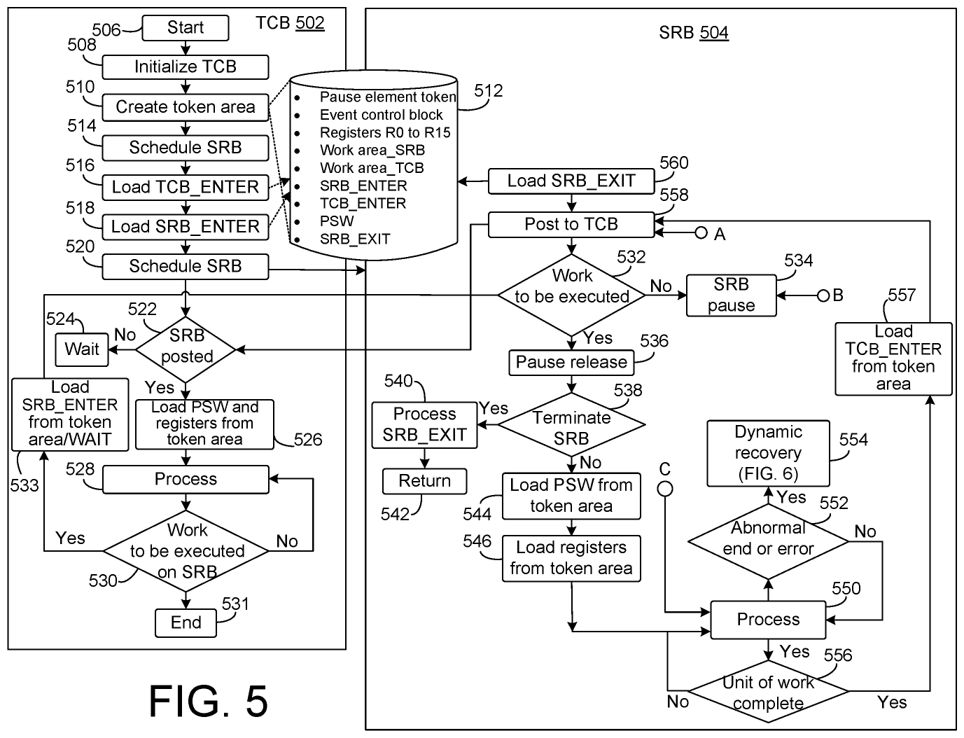

For example, as described in more detail with respect to FIG. 3, the control block 107 (e.g., a TCB) may initialize the control block 109 (e.g., a SRB) at a beginning of execution of an appropriate portion of the workload 116 (e.g., at a beginning of execution of the code 108), and the control block 109 may then wait until it is required (as indicated by the wait status field 124). Then, as described in more detail with respect to FIGS. 4 and 5, when reaching an end of the code 108 within the workload 116, a subsequent line of code may indicate and enable switching to the control block 109 of the second processor 104 to execute the code 110, including putting the control block 107 into a wait or pause state, and storing relevant switching state information existing at an end of execution of the code 108 using the switching state 122. As also described above, the switching state 122 may provide the switching routine addresses 130 of the switching routines 118 and the program status address 128 of a next line of code to execute, as well as relevant register addresses 126 of the registers 114.

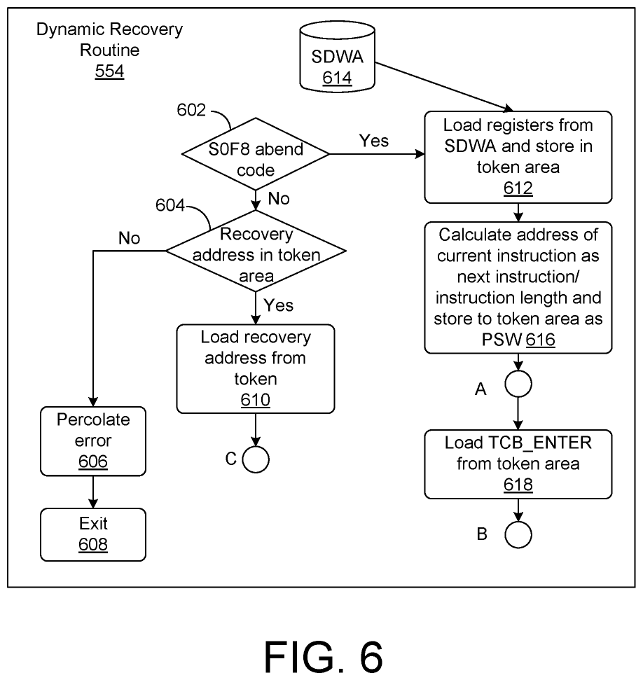

Similarly, upon reaching an end of the code 110, the switching state 122, having been updated as a result of the completion of the code 110, may be provided back to the control block 107. Thus, the control block 109 may return to a waiting state indicated by the wait status field 124, while the control block 107 uses the information from the switching state 122 to resume execution of a code portion of the workload 116 that follows execution of the code 110. As also referenced above and illustrated and described in more detail with respect to FIG. 6, an error or unallowed code portion within the code 110 may also result in control being dynamically switched back to the control block 107.

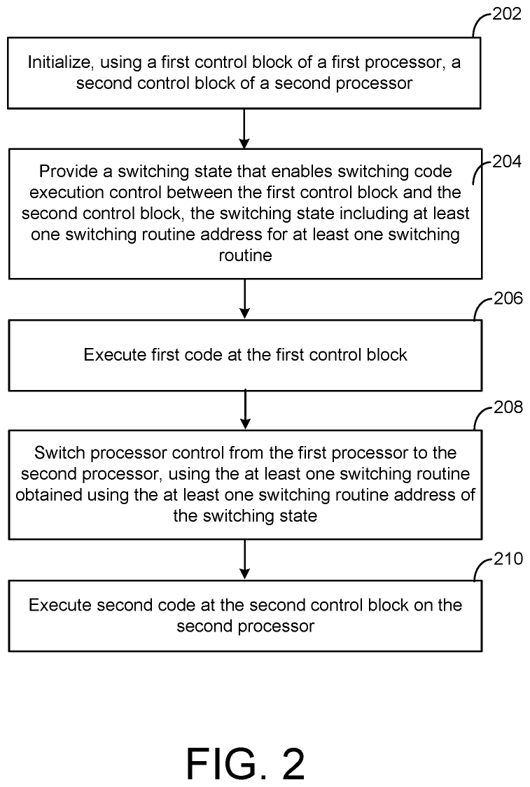

FIG. 2 is a flowchart illustrating example operations of the monitoring system of FIG. 1. In the example of FIG. 2, operations 202-208 are illustrated as separate, sequential operations. In various implementations, the operations 202-208 may include sub-operations, may be performed in a different order, may include alternative or additional operations, or may omit one or more operations. Further, in all such implementations, included operations may be performed in an iterative, looped, nested, or branched fashion.

In the example of FIG. 2, a first control block 107 of a first processor 102 may be used to initialize a second control block 109 of a second processor 104 (202). For example, the control block 107 may represent a TCB that initializes the control block 109 as a SRB running on the second processor 104.

A switching state may be provided that enables switching code execution control between the first control block and the second control block, the switching state including at least one switching routine address for at least one switching routine (204). For example, the control block 107 as a TCB may provide an address for the switching state 122 of FIG. 1 to the control block 109 as a SRB. Upon completion of initialization and providing of the switching state 122, the control block 109 may be put into a wait state, e.g., using the wait status field 124 of FIG. 1.

First code may be executed at the first control block (206). For example, the workload 116 may be executed, and may include the code 108 executing at the control block 107 as a TCB. For example, the code 108 may represent a task or other unit of work to be executed.

Processor control may be switched from the first processor to the second processor, using the at least one switching routine obtained using the at least one switching routine address of the switching state (208). For example, the at least one switching routine 118 may be configured to provide the switching state 122, including relevant register addresses 126 and program status address 128, to the control block 109 at the second processor 104. In conjunction, the control block 107 may enter a wait or pause state.

The second code may thus be executed at the second control block on the second processor (210). For example, the second control block 109 may access relevant data and instructions from the registers 114 and/or the memory 112, using the register addresses 126 and the program status address 128. During execution, the second control block 109 may also continue to update the registers 114 and/or memory 112 with updated values. Then, although not shown separately in FIG. 2, the second control block 109 may return control to the waiting control block 107, including providing the switching state 122, and then itself returning to a waiting state. Accordingly, the first processor 102 and the control block 107 may be provided with current, up-to-date values of data and instructions that exist following completion of execution of the code 110 by the control block 109. Consequently, the first processor 102 may proceed with using the control block 107, or a subsequent control block, to continue executing subsequent code of the workload 116.

FIG. 3 is a block diagram of an example implementation for processor switching. In FIG. 3, a general processor 302 represents an example of the first processor 102 of FIG. 1. A zIIP processor 304 represents an example of the second processor 104 of FIG. 1.

As shown in FIG. 3, a task 1 306, representing a task control block assigned to execute a specific task, may be associated with a SRB 1 308. Similarly, a task 2 310 may be associated with a SRB 2 312, and so on for an X number of TCBs and SRBs.

Thus, FIG. 3 illustrates an example one-to-one nature of tasks or TCBs and corresponding SRB(s). As described herein, for example, the SRB 1 308 may be initialized by the task 1 306, e.g., in conjunction with a creation of the TCB for task 1 306. Then, after receiving the switching state 122 as described above, the SRB 1 308 may be placed into a wait state. During subsequent code execution by the task 1 306, control and code to be executed may be passed to the SRB 1 308 as needed (while the task 1 306 is placed into a wait or pause state). Further, upon completion of such code executed by the SRB 1 308, or in response to an error occurring at the SRB 1 308, control may be passed back to the task 1 306 for further code execution there.

Accordingly, it is not necessary to schedule a new SRB each time a new SRB is needed for execution on the zIIP processor 304. Instead, each SRB may be maintained in a wait state until needed and may be used multiple times by the same task. As a result, overhead associated with processor switching may be significantly reduced in comparison to existing methods of processor switching.

FIG. 4 is a block diagram illustrating more detailed example operations of the example of FIG. 3. FIG. 4, as well as subsequent FIGS. 5-7, are described with respect to example implementations referenced above in the context of a general purpose processor and a zIIP processor, shown in FIG. 4 as general processor 402 and zIIP processor 404.

As referenced above, use of the zIIP processor 404 may provide advantages to users, but may be limited with respect to workloads that are eligible to execute on the zIIP processor 404. For example, workloads may be required to run in SRB mode on the zIIP processor 404, while general purpose workloads executing in TCB mode may execute on the general processor 402.

As also referenced above, conventional approaches are associated with significant overhead when scheduling an SRB and may be limited in a number of times that SRB(s) may be used before the overhead consumes the benefits of the use of the SRB(s). Moreover, conventional approaches cannot perform in-line switching.

As a result, conventional approaches are typically required to schedule only relatively large workloads or workload portions. However, in many cases, a workload may include a large portion that is not SRB-eligible while also including a small portion that is SRB-eligible and that has large processor usage. Such workloads would benefit from zIIP processing but are conventionally unable to be zIIP processed. In other cases, a small portion of a workload may be SRB-ineligible, while a majority of the workload is SRB-eligible. Again, zIIP processing is not feasible in such scenarios in conventional approaches. In described techniques, however, in-line switching between TCB mode and SRB mode enables use of the zIIP processor 404 even for small portions of a workload.

For example, in FIG. 4, after a start (406) operation, workload processing (408) of a code portion may begin. To initiate switching operations, a current environment may be saved (410). For example, the switching state 122 of FIG. 1 may be saved.

A switch to SRB mode may then be executed (412). An SRB-eligible execute function (414) may thus be executed at the zIIP processor 404. Once indicated by a return code (416), the saved environment may be updated (420), e.g., upon completion of the switched function or other code portion. If there is not return code, but an SRB-ineligible code portion is encountered while executing the function, then a function recovery routine may be executed (418), as described with respect to FIG. 6.

The function recovery routine will also result in updating of the saved environment (420). Thus, upon switching to TCB mode (422) to return to the general processor 402, a process (424) may be provided with the updated, saved environment to use in continued processing, until a processing end is reached (426).

FIG. 5 is a block diagram illustrating additional and more detailed example operations of the example of FIG. 4, illustrating a TCB 502 and a SRB 504. In FIG. 5, a unit of work may be started (506) in the context of the TCB 502 being initialized. For example, a z/OS application may be executed as a TCB thread. The corresponding TCB task creates a token memory area (510), referred to as token area (512), as an example implementation of the switching state 122 of FIG. 1, which will be used by both the TCB 502 and the SRB 504.

Specifically, as described above, the token area (512) may be used to save the state of an executing environment, as well as any recovery information. Example content of the token area (512) is provided below in Table 1, and discussed in further detail, below.

TABLE 1

| Field | Description |
|---|---|
| PAUSE Element Token | Used by the SRB 504 when it is waiting for |
| field | work to be assigned |
| Event Control Block (ECB) | Used by the TCB 502 to WAIT for the SRB |
| field | 504 to finish executing |
| Registers R0 to R15 | Sixteen Doubleword Register fields to save |
| | the executing environment that will be |
| | loaded by the waiting unit of work |
| PSW (Program status word) | Address at which a waiting SRB (TCB) |
| area | begins execution upon completion of an |
| | executing TCB (SRB) |
| Work area_SRB | Work area used for SRB PAUSE routine |
| Work area_TCB | Work area used for TCB WAIT routine |
| SRB_ENTER | SRB Switching Routine address |
| TCB_ENTER | TCB Switching Routine address |
| SRB_EXIT | Address used by the SRB 504 during |
| | termination for clean up |

After creation of the token area (512), the TCB 502 may then schedule the SRB 504 (514). The switching routines TCB_Enter (516) and SRB_Enter (518) may then be loaded for inclusion in the token area (512). That is, TCB_Enter represents an example of the switching routines 118 of FIG. 1, which may be used by the SRB 504 to invoke, or switch processing to, the TCB 502. Similarly, SRB_Enter represents an example of the switching routines 118 of FIG. 1, which may be used by the TCB 502 to invoke, or switch processing to, the SRB 504.

The SRB 504 may thus be scheduled (520) and may complete initialization and assume an initial wait state, using an available pause routine (532, 534). For example, the SRB 504 may load its SRB_Exit routine (560) to the token area (512), and then post to TCB 502 (558) availability. For example, posting includes passing the address of the token area (512) back to the TCB 502. Until the SRB 504 has posted (522), the TCB 502 remains in a wait state (524) (e.g., using the event control block (ECB) field and work area_TCB of the token area (512) for the SRB 504 to fully initialize before continuing.

Once the SRB 504 has posted (522) its availability, the TCB 502 may load the Program Status Word (PSW) and register values from the token area (526) and commence processing the assigned task of the TCB 502 (528), which continues as long as no work to be executed on the SRB 504 is encountered (530), or until an end of processing is reached (531).

Otherwise, once work to be done on the SRB 504 is encountered (530), SRB Enter is used to switch control from the token area/WAIT to the SRB 504 (533). Specifically, the TCB 502 may use the SRB_Enter call to save the environment (e.g., save all registers Register 0 through Register 15, load the address of the token area (512) into Register 1, and save the address of the next instruction into the Token PSW address. The TCB 502 may then load the SRB_Enter address from the token area 512 and call the SRB Enter routine. The TCB 502 may then perform a WAIT, to wait until the TCB task needs to start executing again.

Upon determination of work to be executed (532) at the SRB 504, a SRB pause (536) release is issued. Assuming the SRB 504 is not terminated (538), which occurs in conjunction with a unit of work of the SRB 504 or of the TCB 502, then the PSW is loaded from the token area (544) and the relevant register addresses are loaded from the token area (546).

In more detail, the SRB_Enter routine may clear the ECB of the TCB 502, then perform the pause release (536) to come out of wait state and start executing. Once the SRB 504 is released from its PAUSE, the SRB 504 checks the token area (512) to see if the SRB 504 needs to terminate (538). If so, it loads an SRB termination address and branches to the termination address to terminate the SRB (540), and then returns to the operating system (542). Otherwise, the SRB 504 may load the environment from the token area (512) (e.g., the PSW address and Registers R0-R13) (544, 546), and will begin executing from the PSW address (i.e., from where the TCB 502 left off). Then, processing at the SRB may proceed (550) exactly where processing ended by the TCB 502. If an abnormal end (abend) or error occurs (552), then the dynamic recovery routine of FIG. 6 may be implemented (554), as described below.

Otherwise if no abend or error occurs (552), processing continues (550) until the unit of work is complete (556). The SRB 504 may then post back to the TCB 502 (538) using TCB_Enter from the token area (557). As described, TCB_Enter is a routine used to pass control from the running SRB 504 to the waiting TCB 502. TCB Enter loads the address of the token area 512 and performs a POST on the TCB ECB, which tells the TCB to come out of WAIT state and start executing from where the SRB 504 left off. Since, at this point in the process of FIG. 5, there is no work currently to be executed (532), the SRB 504 may proceed to enter a pause or wait state (534).

Operations of the SRB 504 may continue until termination (538). At this point, the SRB_Exit routine may be processed (540), as noted above.

FIG. 6 is a flowchart illustrating an example dynamic recovery operation for use in the examples of FIGS. 3-5. As described above with respect to FIG. 5, a dynamic recovery routine 554 may be implemented. In the following description of FIG. 6, a SOF8 abend code refers to an abend (abnormal end of processing) code that occurs in response to a service call being issued in an SRB environment, e.g., in the context of the SRB 504 of FIG. 5. The SOF8 abend code represents an example of an abend that occurs when an executing SRB encounters code that cannot be executed in a zIIP or SRB environment, such as when a service call is issued in an SRB context. Techniques of FIG. 6 allow dynamic switching back to the TCB environment in such cases, enabling continuation of program execution instead of exiting with error.

In other words, if there is an error while running the SRB 504 of FIG. 5, a function recovery routine such as the dynamic recovery routine 554 of FIGS. 5 and 6 may be called. Depending on the type of error that occurs, the dynamic recovery 554 may be used to either to restore and run the executing code or safely exit and terminate the SRB task.

Initially, if the SRB 504 experiences an abend, the dynamic recovery routine 554 will gain control and a system diagnostic work area (SDWA) 614 may be populated with error related information, as described in more detail, below. The address of the dynamic recovery routine 554 may be loaded by the SRB 504 when the SRB 504 is originally scheduled.

In FIG. 6, if the abend code is SOF8-04 (602), registers 0-15 may be loaded from the SDWA 614 and saved in the token area 512 (612). An address of an abending or current instruction may be stored as PSW in the token area 512 (616), so that the current instruction that caused the abend will be executed again in the TCB 502. For example, in conjunction with the recovery operations, an address of a next instruction and its length may be obtained and may be used to calculate the address of the current and/or abending instruction, and the resulting address may be saved as the PSW in the token area 512 for re-execution at the TCB 502.

Operations then proceed to point A in FIG. 5 to post to the TCB 502 (558), as described above with respect to FIG. 5. For example, operations may post the waiting TCB 502 with return parameters so that program execution may resume. The SRB 504 will load the TCB ENTER routine from the token area (618) and use PAUSE services to wait until further work is provided, as indicated by point B in FIG. 5, and with respect to the SRB pause operation (534). At this point, the TCB 502 has all instructions needed to continue executing, as well as the needed register values. After executing the instruction that caused the abend (e.g., a service call), the operations described above with respect to FIG. 5 may be used to transfer back to the waiting SRB 504, which may then be released to continue working.

If abend code is not SOF8 (602), the token area 512 may be checked for a recovery address (604). If a recovery address is specified, it may be loaded from the token area 512 and set as the next address instruction to resume to in the SRB (610), leading to point C in FIG. 5 and continued processing (550).

If no recovery address is specified (604), the abend can be percolated (606) and the dynamic recovery routine exits (608).

Thus, FIG. 6 illustrates that when the SRB 504 encounters a system error of SOF8, the SRB 504 may dynamically switch to the TCB 502 to perform, e.g., the service call execution. This seamless transition will continue execution of the program instead of exiting with error.

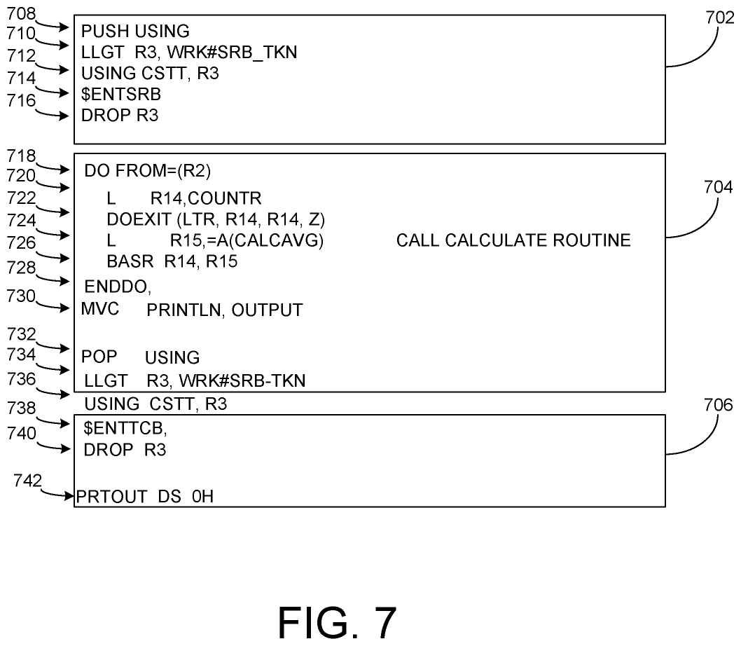

FIG. 7 is an example of program code that may be used in the examples of FIGS. 3-6. FIG. 7 illustrates an in-line nature of described operations. As described in more detail, below, a code portion 702 may be executed in a TCB, such as the TCB 502 of FIG. 5, a code portion 704 may be executed in an SRB, such as the SRB 504 of FIG. 5, and then a final code portion may be executed in the TCB 502 of FIG. 5. In the simplified example of FIG. 7, the SRB 504 may be used to execute an example ‘calculate’ routine.

In FIG. 7, line 708 executes a PUSH instruction to save a current USING status in push-down storage. Line 710 loads a token area (such as the token area 512 of FIG. 5) into register 3 (R3). Line 712 indicates use of register 3, and in line 714, an implementation of the switching routine SRB_Enter is provided through the use of a macro call $ENTSRB before a DROP instruction is provided in line 716 to end the domain of the previous USE instruction.

A simple example do loop is executed at lines 718, 720, 722, 724, 726, 728, to provide an example of a routine processed in an SRB environment. As shown, line 718 illustrates that registers R2, R14, and R15 may be used to obtain required data and instruction addresses for the ‘calculate’ routine, following by an output instruction in line 730. In line 732 a POP instruction restores a USING status saved by a most recent PUSH instruction. Then, as described above with respect to lines 710 and 712, the token area (e.g., token area 512) may be loaded from register 3.

Similarly to the SRB_Enter switching routine, a macro call for a TCB_Enter routine may be executed in line 738 as $ENTTCB. In lines 740 and 742, register R3 may be dropped and any desired TCB processing may continue, including, e.g., an output of a result of the ‘calculate’ routine.

FIGS. 1-7 thus illustrate example of seamless, low-overhead processor switching that requires few CPU instructions. For example, described techniques may avoid the overhead of scheduling an SRB whenever a unit of work can be zIIP enabled. Instead, described techniques may perform a PAUSE RELEASE operation(s) on a waiting SRB to enable the specified unit of work as zIIP enabled. As a result, for example, it is straightforward to implement and zIIP-enable existing code bases. For example, the inline solutions of FIG. 7 enable a plug-and-play implementation that essentially involves only the inclusion of the SRB_ENTER and TCB_ENTER macros, and associated used of a designated token area, with respect to existing code.

Moreover, errors during SRB processing may be seamlessly handled by the dynamic recovery routine or switching routine, resulting in dynamic switching from the SRB to the TCB when error is caused by execution of included instructions.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, a server, a mainframe computer, multiple computers, or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
initialize, using a first control block of a first processor, a second control block of a second processor;
provide a switching state that enables switching code execution control between the first control block and the second control block, the switching state including at least one switching routine address for at least one switching routine;
execute first code at the first control block;
switch processor control from the first processor to the second processor, using the at least one switching routine obtained using the at least one switching routine address of the switching state; and
execute second code at the second control block on the second processor.

2. The computer program product of claim 1, wherein the first control block includes a task control block and the second control block includes a service request block.

3. The computer program product of claim 1, wherein the instructions are further configured to cause the at least one computing device to:
provide the switching state using a memory area that is accessible to the first control block and the second control block.

4. The computer program product of claim 1, wherein the switching state includes an address of a line of code of the second code at which the second control block begins executing the second code.

5. The computer program product of claim 1, wherein the switching state includes register addresses of registers storing data calculated by the first code and used by the second control block to execute the second code.

6. The computer program product of claim 1, wherein the instructions are further configured to cause the at least one computing device to:
execute the first code at the first control block while the second control block is in a first wait mode; and
execute the second code at the second control block while the first control block is in a second wait mode.

7. The computer program product of claim 1, wherein the instructions are further configured to cause the at least one computing device to:
complete execution of the second code at the second control block;
use the switching state to transfer control back to the first control block; and
execute third code at the first control block.

8. The computer program product of claim 1, wherein the instructions are further configured to cause the at least one computing device to:
encounter a code portion of the second code that is not executable by the second control block; and
use the switching state to transfer control back to the first control block; and
execute the code portion at the first control block.

9. The computer program product of claim 8, wherein the instructions are further configured to cause the at least one computing device to:
use the switching state to transfer control back to the second control block; and
execute a remainder of the second code at the second control block.

10. The computer program product of claim 1, wherein the instructions are further configured to cause the at least one computing device to:
encounter a line of code of the first code that calls the at least one switching routine;
execute the at least one switching routine using the at least one switching routine address obtained from the switching state; and
execute a next line of code as part of the second code in the second control block.

11. A computer-implemented method, the method comprising:
initialize, using a first control block of a first processor, a second control block of a second processor;
provide a switching state that enables switching code execution control between the first control block and the second control block, the switching state including at least one switching routine address for at least one switching routine;
execute first code at the first control block;
switch processor control from the first processor to the second processor, using the at least one switching routine obtained using the at least one switching routine address of the switching state; and
execute second code at the second control block on the second processor.

12. The method of claim 11, wherein the switching state includes an address of a line of code of the second code at which the second control block begins executing the second code.

13. The method of claim 11, wherein the switching state includes register addresses of registers storing data calculated by the first code and used by the second control block to execute the second code.

14. The method of claim 11, further comprising:
executing the first code at the first control block while the second control block is in a first wait mode; and
executing the second code at the second control block while the first control block is in a second wait mode.

15. The method of claim 11, further comprising:
completing execution of the second code at the second control block;
using the switching state to transfer control back to the first control block; and
executing third code at the first control block.

16. The method of claim 11, further comprising:
encountering a code portion of the second code that is not executable by the second control block; and
using the switching state to transfer control back to the first control block; and
executing the code portion at the first control block.

17. A system comprising:
at least one memory including instructions; and
at least one processor that is operably coupled to the at least one memory and that is arranged and configured to execute instructions that, when executed, cause the at least one processor to
initialize, using a first control block of a first processor, a second control block of a second processor;
provide a switching state that enables switching code execution control between the first control block and the second control block, the switching state including at least one switching routine address for at least one switching routine;
execute first code at the first control block;
switch processor control from the first processor to the second processor, using the at least one switching routine obtained using the at least one switching routine address of the switching state; and
execute second code at the second control block on the second processor.

18. The system of claim 17, wherein the instructions are further configured to cause the at least one processor to:
execute the first code at the first control block while the second control block is in a first wait mode; and
execute the second code at the second control block while the first control block is in a second wait mode.

19. The system of claim 17, wherein the instructions are further configured to cause the at least one processor to:
complete execution of the second code at the second control block;
use the switching state to transfer control back to the first control block; and
execute third code at the first control block.

20. The system of claim 17, wherein the instructions are further configured to cause the at least one processor to:
encounter a code portion of the second code that is not executable by the second control block; and
use the switching state to transfer control back to the first control block; and
execute the code portion at the first control block.
